(19) United States
(12) Patent Application Publication
(10) Pub. No.: US 2007/0105979 A1
(43) Pub. Date: May 10, 2007

(54) Metal colloid dispersions and their aqueous metal inks

(75) Inventor: Jing X. Sun, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lemark International, Inc.

(21) Appl. No.: 11/269,982

(22) Filed: Nov. 9, 2005

(51) Int. Cl. C09D 11/00

(52) U.S. Cl. 523/160; 523/161

(57) ABSTRACT

A silver dispersion is obtained by reducing a silver compound in the presence of a polymeric dispersant of an ionic hydrophilic segments, such as methacrylic acid segments and nonionic hydrophilic segments of alkoxy-terminated polyethylene glycol segments. Aqueous inkjet inks may contain such dispersants and other common ingredients such as a humectant. The printed inks can be sintered under heat to form solid, conductive patterns of silver.

### TECHNICAL FIELD

This invention relates to colloid dispersions of elemental metal, or its alloy, such as silver, and inks having metal for printing or other applications of the metal.

### BACKGROUND OF THE INVENTION

One significant topic in the thermal ink jet printing field is whether it can be used to print the nano-sized metal particles. Application of this technology can bring the ink jet printing into a broader market such as electronic equipment and optic materials manufacture. To reach this target, the first requirement is to make a stable aqueous based metal colloid dispersion.

Generally, two ways appear known to make the aqueous metal dispersions. The physical method is to directly disperse the metal in the presence of a dispersing agent with high energy. Another method also widely used is the chemical reduction method. It is well known that silver salts can be reduced to silver metal by chemical reducing reagents. Commonly used reducing reagents are borohydrides, citrate salts; ascorbic acid, hydrazine, glucose, hydrocarbons and hydrogen. Therefore, using this approach to prepare metal colloid in the aqueous medium has great convenience and advantage.

There are also many ways to prevent the metal colloid to agglomerate and precipitate. Commonly used are the stabilizers such as surfactants, polyelectrolytes, gelatin, polyphosphates, amino grafted polymer, or oligomer, dendrimer, crown ethers and amphiphilic polymer such as carboxymethyl cellulose sodium salt (CMC).

Previously reported literature for the chemical reduction include IS&T's NIP19 2003 International Conference on Digital Printing Technology, pages 656-659, by Nippon Paint; Chem. Mater., 2003, 15, pages 2208-2217 and J. Phys. Chem. 1982, 86, pages 3319-3395, and WO patent application 03/038002A1, WO 02/094954A1, and WO 02/094953A1. Each method has its own advantages and disadvantages. For example, WO 03/038002A1 uses the CMC as the stabilizer and the citric acid presidium salt as the reducing reagent.

High molecular weight CMC could increase the viscosity of the dispersion. Carboxylic groups is not compatible with the silver salt in the reduction system, so the concentration of the silver and the number of the carboxylic groups are very sensitive in the reaction. This method introduces a large amount of salts into the system, which not only limits its selection of the stabilizing reagent, also final remove of the excess salt is required to render the system compatible with the ink jet printing. The reduction has to be finished at high temperature, also limited the equipment and increased the cost.

An industrial production system which is cheaper, better control of the metal particles size distribution, stability and readily adapted to inkjet and other printing applications is needed in the art.

Earlier internal activity subject to common ownership with this invention and currently the subject of U.S. patent application Ser. No. 10/925,042, of Guan et al teaches employing the chemical reduction in an aqueous medium of a metal salt to the elementary metal colloid in the presence of a polymeric dispersant for the elementary metal colloid. The polymeric dispersants have ionic hydrophilic segments and nonionic hydrophilic segments. Such a dispersion is employed in aqueous inkjet inks having standard ingredients, particularly a humectant to reduce evaporation. The inks when printed on a solid substrate leave silver which is sintered by heat to a solid, conductive pattern. The nonionic component of the specific dispersants taught was hydroxyl terminated polyethylene glycol functional groups.

That teaches that the polymeric dispersant may be somewhat made like dispersants which have been developed in recent years for the pigmented inks in inkjet. But there are also some fundamental differences. It is preferred that the dispersant is an acrylic polymer contains at least two major components: anionic segments and non-ionic segments. The anionic segments contains monomer having the carboxylic acid or sulfonic acid functional groups, which provides the electrostatic stability of the dispersion. The acid groups also provide the ability of interaction between silver and the polymer. The non-ionic segments are chosen from the hydroxy terminated polyethylene glycol monomers. It not only provides the steric stabilization, the hydrogen bonding interaction with the silver, but also give the solubility of the dispersion in the water/organic solvent therefore provides the ink printing reliability. It is also preferred that the PEG monomer has a molecular weight lower than 1000.

The polymer is a random co- or ter-polymer made through free radical polymerization. The molecular weight is controlled by a chain transfer reagent. Any kind of mercaptane compound can be used as the chain transfer reagent. Preferred chain transfer reagent in this reaction contains the hydroxy or acid functionality, such as 2-mercaptoethanol, 3-mercaptoethanol, mercaptoacetic acid, mercaptopropionic acid. 3-mercapto-1,2-propanediol.

The carboxylic acid content is very important in the dispersion. Too less will not provide the stability of the colloid preferred. Too much will also not compatible with the silver salt and result in large metal particle formation, plus the silver conductivity may drop. The actual content can be judged in the reduction. Less than 50 wt % of acid is preferred, less than 20% of acid is more preferred.

The molecular weight is a not very important factor, and can be judged by the art in the term of dispersant and ink jet printing reliability. Too high molecular weight will increase the viscosity of the ink. But too low will not provide the stability of the dispersion also. Preferable from 8000 to 1000 by weight average molecular weight.

The reducing reagent used here is hydrazine. According to the general equation: 4Ag++N2H4 - - - →4Ag+N2+4H+ (J. Appl. Polym. Sci. 1992, Vol. 44, pages 1003-1007 and Langmuir 2000, 16, pages 9087-9091) the reaction is very simple and can be completed at room temperature. The bi-product is a gas, which made the final product easy to be purified. Because of the existence of the stabilizer, the concentration of the silver can also be adjusted in the process.

It is believed the particle size of the silver colloid is controlled by several factors. First is the dispersant. The acid functions to interact and stabilize the silver colloid. But the quantity of the acid groups directly influence the conductivity of the silver and the solubility of the silver salt. The solubility of the silver salt affects the particle size. The best quantity of the acid is that it will form a clear solution with the silver nitrate. If the clouds form, the particle size of the silver will be higher than expected. Second is the process. This reaction's bi-product is a gas. It generates foam in the reaction. Therefore, control the stirring speed, the addition speed and the ratio of the silver salt and the hydrazine is very important. It is preferred that the silver salt/dispersant solution and the hydrazine be dropped simultaneously to a dispersant solution. The dropping speed is silver salt faster than hydrazine. The last thing is the amount of the dispersant. Although it looked like the quantity of the dispersant is not very important in the particle size formation period, to maintain its stability through out the shelf life while reaching the required conductivity and adhesion to the media, the ratio becomes very important. Preferred ratio of silver to dispersant 2 to 1 to 15 to 1 by weight. Most preferred the ratio is about 7.5 to 1 by weight.

Some commercial polymers have the ability to disperse the silver colloid particles, such as polyacrylic acid. But, to reach the required particle size, the concentration, the required storage stability, the conductivity, and the thermal ink print head reliability, this embodiment employs selected the monomer for this unique purpose. Generally speaking, a homopolymer of polyacrylic acid (PAA) produces larger size of silver colloid particles compared with co-polymer of this invention. The stability and printing reliability are also not as expected as the co-polymer. But it can be used as a co-stabilizer in the reaction system, its acid functionality can provide the buffer ability to the reaction system.

As illustrative of that invention, the random co-polymer of methacrylic acid and polyethylene glycol methacrylate (MAA/PEGMA); and co-polymer of MAA/Tris (polyethyleneglycol)2,4,6-tris 1-phenylethylphenylether methacrylate), are used here. Hydrazine monohydrate is used as the reducing agent.

The general methods of synthesis of the co-polymers are as follows:

A mixture of polyethylene glycol methacrylate (mw360) 54 g and methacrylic acid 8 g, 3-mercapto-1,2-propanediol 2.8 g, iso-propanol 100 ml and V-601(dimethyl 2,2′-azobisisobutyrate) 0.2 g is mixed in a 300 ml three neck round bottom flask equipped with a mechanical stir, condenser and thermometer. The flask equipment is de-gassed, back filled with nitrogen and then heated to 75 C in an oil bath for 18 hours. The solvent is then removed by evaporation and the mixture is neutralized with 20% KOH solution in De-ionized water. Final pH is 7.0.

The reduction is carried out in the following methods:

1. Using Polymer dispersant A

In a 200 ml flask, 50 ml of DI water and 0.2 g pure dispersant is mixed.

Prepare separately
1) 1 g silver nitrate in 50 ml DI water and 0.2 g dispersant (assure it is a clear solution)
2) 0.4 g hydrazinemonohydrate (98%) in 50 ml DI water.
   Dropping 1 and 2 solution at the same time to the flask with good stirring. The dropping speed of silver nitrate is slightly faster than the hydrazine. Assure there is no foaming of the reaction. After addition of the silver nitrate, dropping of the hydrazine is continued while testing the completion of the reduction by using the ascorbic acid sodium salt solution until no black precipitate will be generated. At the point that the mixture does not generate black precipitate with the ascorbic acid, addition of the hydrazine solution can be stopped. The mixture is continued stirring for another hour, check the particle size by the MICROTRAC UPA 150 instrument. The particle size is about 16-29 nm. The final silver colloid is concentrated by ultra-filtration to the concentration of 10 to 30%.

2. Using polymer dispersant A and the method as described above, except the amount of polymer dispersant and the hydrazine are each ⅓ of the above; the particle size is 22 nm.

3. Using polymer dispersant A and the method as described in 1) above, except the amount of the hydrazine is increased ⅓ to about 0.53 g; the particle size is 24 nm.

4. In a 200 ml flask, 50 ml of DI water, 0.1 g of PAA sodium salt and 0.13 g pure dispersant is mixed.

Prepare separately
3) 1 g silver nitrate in 50 ml DI water and 0.13 g dispersant (assure it is a clear solution)
4) 0.4 g hydrazinemonohydrate (98%) in 50 ml DI water.
   Dropping 1 and 2 solution at the same time to the flask with good stirring. The dropping speed of silver nitrate is slightly faster than the hydrazine. Assure there is no foaming of the reaction. After addition of the silver nitrate, dropping of the hydrazine is continued while testing the completion of the reduction by using the ascorbic acid sodium salt solution. At the end of the reaction the mixture does not generate black precipitate with the ascorbic acid. The mixture is continued stirring for another hour, check the particle size by the MICROTRAC UPA 150 instrument. The particle size is about 20-30 nm. The final silver colloid is concentrated by ultra-filtration to the concentration of 10 to 30%. (The PAA Mw can be from 1000 to 15,000. Prefer about 5000 to 8000)

Similar polymer solutions are made by the same method with the following formulation

| | A | B | C | D | E | F | G |
|---|---|---|---|---|---|---|---|
| PEGMA(360) | 54 | 43 | | 25 | 43 | | 54 |
| PEGMA(526) | | | 25 | | | | |
| Tris | | | | | | 50 | |
| MAA | 13 | 21 | 43 | 43 | 21 | 25 | 8 |
| 3-mercapto- | 3.6 | 3 | 2 | 2 | 1.5 | 1.1 | 2.8 |
| 1,2propanediol | | | | | | | |
| Particle Size(nm) | 15-25 | 28 | 106 | 245 | 125 | * | 29 |

* high viscosity

An illustrative ink formulation used for printing is as follows: The particle size of the silver is preferred between 10 to 30 nm.

68 g of the silver colloid dispersion made from polymer dispersant A

4.3 g glycerol

4.3 g 2-pyrrolidone

0.2 g SURFANOL 465 (an acetylene surfactant from Air Product)

Silver content of this ink is 13.5% by Inductive Coupled Plasma (ICP) measurement. Particle size 16 nm; viscosity 2.2 cp; pH is adjusted with a base to 6.0.

Printing may be on the coated surface of commercially available papers for inkjet printing. These papers typically have gelatin or porous ceramic coating to receive ink. The sintering temperatures do not destroy these paper so the resulting paper is suitable as an electrical element to be covered in a lamination or otherwise encased.

Printing with this illustrative ink on water absorptive substrate, followed by sintering under heat, produced electrical conductive patterns. Process can be variable, include print pass (i.e., how many 600 dpi layers are laid on the media), print mode (full density vs. shingling mode), sinter temperature and sinter time. For full density print pattern, 600 dpi ink drop will be laid down after one swath. For shingling print pattern, it needs two repeat swathes to get 600 dpi ink drop density. The result indicates that the best performance of the described ink has a sheet resistance 0.16/square.

### DISCLOSURE OF THE INVENTION

This invention is an improvement of the foregoing commonly owned invention by using an alkoxy terminated polyglycol as the nonionic component of the dispersant.

This significantly improves control of the polymerization consistency and particle size of the ink and provides lower resistivity and good adhesive ability of the ink for equivalent particle sizes and concentration of the metal. The silver to dispersant ratio remains important at about 2:1 to about 15:1 by weight, preferably about 7.5:1 by weight.

### DESCRIPTION OF THE PREFERRED EMBODIMENTS

The polymeric dispersant of this improvement has similar but some fundamental changes compared with the foregoing commonly-owned embodiments of the silver dispersant. It is preferred that the dispersant contains at least two major components: anionic and non-ionic segments. The Anionic segment contains monomer having the carboxylic acid or sulfonic acid functional groups, which provides the electrostatic stability of the dispersion. The non-ionic segments are chosen from the short chain alkoxy terminated polyethylene glycol monomers. It not only provides the steric stabilization and the coordination to the silver, but also gives the solubility and compatibility of the dispersion in the water/organic solvent based ink system, therefore provides the ink printing reliability.

Generally, hydroxy terminated groups of the foregoing commonly owned invention have better interaction than the alkoxy terminated groups. But the disadvantage of the hydroxy terminated group is that it is usually not pure and may contain non-functional and bi functional chemicals in its acrylate derivatives. Hydroxyethyl methacrylate, hydroxypropyl methacrylate, or glycerol methacrylate are the monomers that are substantially pure and that can be directly used. For other such hydroxyl-terminated molecules, purification is needed.

The alkoxy terminated monomer does not have the purity problem. The most important property of the new structure is that it improves the conductivity at the same silver to dispersant ratio, lowers the viscosity with no cross-linking and without reducing the media adhesion ability of the silver to the printing media.

Theoretically, the dispersant is used to protect the metal colloid from agglomerating. But for use in an ink a specific property needed for the dispersant is: to protect the colloid in the aqueous phase while separating out or leaving the metal on the surface of the media to provide the metal conductivity. The separation can be accelerated by the heating or sintering process. Therefore, the dispersant can not be too interactive with the metal surface. If there is no separation on the media, the conductivity will be greatly reduced and the ink has no electronic application value. (The dispersant of the foregoing common-owned invention has much stronger attaching characteristic to the silver than the dispersant of this invention.)

The dispersant of this invention is a random acrylic co- or ter-polymer made through free radical polymerization. The molecular weight is controlled by a chain transfer reagent. Any kind of mercaptan can be used as the chain transfer reagent in the polymerization. Preferred chain transfer reagent in this reaction contains the hydroxy, or acid terminated mercaptans such as 2-mercaptoethanol, 3-mercaptopropanol, mercaptoacetic acid, mercaptopropionic acid, 3-mercapto-1,2-propanediol.

The carboxylic acid content is very important in the dispersion. Too little acid will not provide the stability of the colloid preferred. Too much will hurt the silver conductivity. The actual acid content can be balanced by the required stability and conductivity. Generally speaking, less than 35 mol % is necessary. Typically, methacrylic acid is selected in the reaction.

The alkoxy terminated polyethylene glycol (meth)acrylate monomer is preferred to have a low molecular weight. The main reason to choose the low molecular weight monomer is because of the consideration of the viscosity of the ink. Preferred monomers are: methoxypolyethylene glycol monomethacrylate from Nippon Nyukazai Co. under the name of PME-100; 200, 350, 400. And polyethylene glycol ethyl ether methacrylate (Mw 246); polyethylene glycol methyl ether methacrylate (Mw 300, Mw 475); ethylene glycol methyl ether (meth)acrylate; diethyleneglycol methyl ether (meth)acrylate. (Mw is a short representation of weight average molecular weight.)

The molecular weight is another factor affecting the viscosity, stability and conductivity. Preferred molecular weight is around 3000 to 10000 by weight average molecular weight. More preferred is from 5000 to 9000.

The reducing agent used here is hydrazine. According to the general equation: 4Ag++N2H4 - - - →4Ag +N2+4H+ (J. Appl. Polym. Sci. 1992, Vol 44 pages 1003-1007; and Langmuir 2000, 16, pages 9087-9091). The reaction is very simple and can be completed at room temperature. The by-product is a gas, which have no effect on the dispersion's stability and the product is easily purified. Because of the existence of the stabilizer, the concentration of the silver can be adjusted in the process.

It is found that the particle size of the silver colloid, which will directly affect the stability, is controlled by several factors. First is the dispersant's acid quantity. The acid has strong interaction on the metal surface. The quantity of the acid groups directly influences the stability of the dispersion and the particle size. Typically, the more acid the better the stability. But there are other factors need to be considered. The more stable the dispersion, the more difficult for the dispersant to separate form the metal and therefore the poorer the conductivity. Also, carboxylic acid is not compatible with the silver salt used for reduction. Precipitation of the silver salt needs to be prevented. Second is the molecular weight of the dispersant. The higher molecular weight can typically give a more stable dispersion because of the steric effect, but it also affects the ink's viscosity. For a thermal ink jet printer, the viscosity has a specific requirement.

Third is the process. The by-product of the reaction is a gas. It generates foam in the reaction. Therefore, control the stirring speed, the addition speed of the silver salt to the dispersant is very important. Adding one component to the other component is an acceptable process. But the more preferred process is adding both components to a reaction at the same time with a speed of silver salt/dispersant to reducing agent 4:1.

The next factor is the pH of the reaction. This reaction generates protons so the pH of the mixture is dropping during the process. But at the beginning of the reaction, because hydrazine is a strong base, the pH can be raised very high by the addition of hydrazine if the dropping speed is fast. This can result in undesirably large particle size metal being generated.

The last factor is the metal to dispersant ratio. The lower the ratio, the smaller the particle size, but also the poorer the conductivity. Preferred ratio of silver to dispersant is 2.4:1 to 20:1.

The general method of synthesis of the co-polymers is as follows:

Dispersant A

Polyethyleneglycol methyl ether methacrylate (mw around 300) 33 g; methacrylic acid 4.8 g; 3-mercapto-1,2-propanediol 0.88 g; isopropyl alcohol (IPA) 200 ml and V-601 (dimethyl 2,2′-azobisisobutyrate) 0.2 g is mixed in a 500 ml three neck round bottom flask equipped with a mechanical stir, condenser and thermometer. The flask equipment is de-gassed and back filled with nitrogen, then heated to 75 C in an oil bath for 18 hours. The solvent is then removed by distilling out the solvent and back fill the DI water. The final solution is neutralized to pH 6.0 with 20% KOH. The solution has 20% solid; the molecular weight is measured as 7474 Mw by gel permission chromatography (GPC).

### The Control Dispersant

Polyethyleneglycol methacrylate (mw around 360) 54 g; methacrylic acid 3.7 g; 3-mercapto-1,2-propanediol 2.3 g; IPA 200 ml and V-601 (dimethyl 2,2′-azobisisobutyrate) 0.2 g is mixed in a 500 ml three neck round bottom flask equipped with a mechanical stir, condenser and thermometer. The flask equipment is de-gassed and back filled with nitrogen, then heated to 75 C in an oil bath for 18 hours. The solvent is then removed by distilling out the solvent and back fill the DI water. The final solution is neutralized to pH 6.0 with 20% KOH. 20% solid; the molecular weight is measure as Mw 8134 by GPC.

### The Reduction (2.4:1 Ratio of Silver to Dispersant)

Prepare:

100 g silver nitrate with 26.5 g dispersant A (a weight ration of 4 to 1) is dissolved in total of 4580 g DI water.

53.7 g of the 35% hydrazine is mixed in 3226 g DI water. In a 15 L beaker, add 2000 g DI water and 260 g of the silver/dispersant mixture. Dropping in hydrazine solution very slowly with the Masterflex L/S addition pump made from Cole-Parmer Instrument Co., about 15 g of the solution is added and the pH of the solution in the beaker is gradually dropped to about 6. Stop the addition and let the reaction continue until the pH of the solution is about 5. At this time, begin to drop the silver/dispersant solution at the speed of 6 and the hydrazine speed at 1 until the pH of the reaction mixture dropped to about 4. Then adjust the speed ratio of silver/dispersant to hydrazine to 12:3; then to 24:6. until all the silver/dispersant solution is added. Continue to add the hydrazine at the same speed till finish. The final pH is about 2-3. Raise the pH with 3% KOH solution to pH 7. The resulting particle size is 29.2 nm by Microtrac UPA 150 instrument.

The final solution is concentrated through the ultrafiltration (RO) with the memberence Mw 1000 filter. At about 2 L left, washing with 2 L of DI water and maintain pH at 6 with 3% KOH. Finally concentrate to 35% silver. The particle size of the silver was about 23.9 nm. Reaction yield was about 95.6%.

The same process is carried out with the control dispersant C, except in the C dispersant contains about 30% of the polyethylene glycol (PEG), so the real silver to dispersant ratio is about 3.5:1. This results in 36% silver, pH 6.0; particle size 24.00, yield 94.5%.

Ink is made with 14% and 17% silver respectively; (The A ink has silver to dispersant ratio of 2.4:1 by weight; The C ink has silver to dispersant ratio of 2.4:1 by weight, and the D ink has silver to dispersant ratio of 7.5:1 by weight.) The C ink and the D ink have the control dispersant only.

Typical formulation is:

14% or 17% Ag %
10% 2P
10% glycerol
1% SURFANYL 465 (an acetylene surfactant from Air Product)

Balance DI water to 100 g

Ink Comparisons Table

| | | Viscos- | P(size) | Surface | % Ag | Resistivity | |
|---|---|---|---|---|---|---|---|
| | pH | ity (cp) | (nm) | tension | by TGA | (ohms/sq)2× | 4× |
| A(14%) | 6 | 6.33 | 27 | 36 | 14.3 | 0.093 | 0.073 |
| A(17%) | 6 | 6.32 | 27 | 35.5 | 17.3 | 0.073 | 0.055 |
| C(14%) | 6 | 6.26 | 23 | 35.8 | 13.8 | 0.131 | 0.093 |
| C(17%) | 6 | 6.35 | 23 | 35.9 | 17.3 | 0.113 | 0.100 |
| D14% | 6 | 3.62 | 47 | 37 | 14.5 | 0.091 | 0.051 |
| D17% | 6 | 4.03 | 47 | 35 | 17.6 | 0.076 | 0.042 |

X denotes the pattern by which the ink dots are applied on the media; 4X is a 2 by 2 rectangle of dots.

As shown in this table, the resistivity of the Control type of dispersant at silver/dispersant ratio to 7.5:1 (the D ink) reached the new dispersant's 2.4″1 level. However, the higher the silver to dispersant ration, the more chance for the instability of the ink and for poor adhesion of the printer ink on the media.

In summary, the dispersant with alkoxy-terminated nonionic component has several advantages over the previous dispersant. First the monomer is in higher purity than the old monomer, which makes the polymerization process easier to control the molecular weight and cross-linking side products. Second the new dispersant has a relatively less interaction with the silver, so that with the ability to achieve a stable dispersion and good adhesion to the media, we can also get a higher conductivity. Third, the viscosity of the ink is also easier to be controlled and therefore to be that suitable for the thermal inkjet printing.

Although described with specific embodiment of silver, other metals can similarly be reduced and therefore the invention extends to metals in general.

What is claimed is:

1. A method of forming a metal dispersion comprising:
reducing a metal compound with an aqueous soluble reducing reagent in an aqueous medium in the presence of a polymeric dispersant comprising ionic, hydrophilic segments and nonionic, hydrophilic segments, said nonionic segments comprising alkoxy-terminated polyethylene glycol functional groups.

2. The method as in claim 1 in which said metal is silver.

3. The method as in claim 1 in which said ionic hydrophilic segments of said dispersant contains carboxylic acid functional groups.

4. The method as in claim 1 in which said alkoxy-terminated polyethylene glycol is methoxy terminated.

5. The method as in claim 4 in which said ionic hydrophilic segments of said dispersant contains carboxylic acid functional groups.

6. The method as in claim 2 in which said ionic hydrophilic segments of said dispersant contains carboxylic acid functional groups.

7. The method as in claim 2 in which said alkoxy-terminated polyethylene glycol is methoxy-terminated.

8. The method as in claim 7 in which said ionic hydrophilic segments of said dispersant contain carboxylic acid functional groups.

9. The method as in claim 8 in which the ratio of said silver to the dispersant is about 2:1 to 15:1 by weight.

10. The method as in claim 9 in which the ratio of said silver to the dispersant is about 7.5:1 by weight.

11. An inkjet ink comprising a humectant and silver dispersed in an aqueous vehicle by a polymeric dispersant comprising ionic hydrophilic segments and nonionic functional segments, said nonionic segments comprising alkoxy-terminated polyethylene glycol functional groups.

12. The ink as in claim 11 in which said alkoxy-terminated polyethylene glycol is methoxy terminated.

13. The ink as in claim 11 in which said ionic hydrophilic segments of said dispersant contain carboxylic acid functional groups.

14. The ink as in claim 12 in which said ionic hydrophilic segments of said dispersant contain carboxylic acid functional groups.

15. The method of printing metal patterns on solid substrates comprising printing a pattern on a solid substrate using the ink of claim 11 and then sintering the silver applied by said printing by heat.

16. The method of printing metal patterns on solid substrates comprising printing a pattern on a solid substrate using the ink of claim 12 and then sintering the silver applied by said printing by heat.

17. The method of printing metal patterns on solid substrates comprising printing a pattern on a ceramic substrate using the ink of claim 13 and then sintering the silver applied by said printing by heat.

18. The method of silver patterns on solid substrates comprising printing a pattern of a solid substrate using the ink or claim 14 and then sintering the silver applied by said printing by heat
